(19) United States
(12) Patent Application Publication
(10) Pub. No.: US 2026/0112134 A1
(43) Pub. Date: Apr. 23, 2026

(54) AUGMENTED OR MIXED REALITY ASSEMBLY MAINTENANCE SYSTEMS AND METHODS

(71) Applicant: AIS Technologies Group, Windsor (CA)

(72) Inventors: Sarina MUSCEDERE, Windsor (CA); Ahmad SHAWKY, Windsor (CA); Jordan SCOTT, Windsor (CA); Cameron WATSON, Windsor (CA)

(21) Appl. No.: 19/364,214

(22) Filed: Oct. 21, 2025

Related U.S. Application Data
(60) Provisional application No. 63/709,751, filed on Oct. 21, 2024.

(51) Int. Cl. G06T 19/00; G06F 3/0346; G06T 7/73; G06T 19/20

(52) U.S. Cl. CPC G06T 19/006; G06T 7/73; G06T 19/20; G06F 3/0346; G06T 2207/30204; G06T 2219/2004

(57) ABSTRACT

An example method comprises: capturing one or more images of a real-world scene, the scene including an assembly; identifying the assembly using an optical fiducial corresponding to the assembly imaged in at least one of the captured images of the scene; retrieving, from a context repository, data associated with the assembly, the data including a virtual model of the assembly and one or more known processes associated with the assembly; selecting a selected known process from the one or more known processes; displaying an image feed representing the scene and the model of the assembly overlaid over the scene; and outputted one or more instructions corresponding to the selected known process.

### CROSS-REFERENCE TO RELATED APPLICATION

This application claims priority to U.S. provisional Ser. No. 63/709,751 filed on Oct. 21, 2024 and entitled “INTERACTIVE MAINTENANCE MANUAL”. The entirety of U.S. provisional Ser. No. 63/709,751 is hereby incorporated by reference for all purposes.

### FIELD

This disclosure is in the field of augmented reality (AR) or mixed reality (MR) modeling, and in particular relates to use of AR or MR modeling of assemblies that may undergo maintenance or repair.

### BACKGROUND

Assemblies may include many components. How each of the components is interconnected within an assembly may be complex and may make maintenance or repair of the assembly difficult and/or time consuming. If an assembly includes many components (such as more than a hundred components, for example), locating a particular component may be difficult and/or time consuming.

Improved systems and methods for modeling an assembly are desirable.

### SUMMARY

One aspect of the present disclosure provides a method comprising: capturing one or more images of a real-world scene, the real-world scene including an assembly; identifying the assembly using an optical fiducial imaged in at least one of the one or more captured images of the real-world scene; retrieving, from a context repository, data associated with the assembly, the data including a virtual model of the assembly and one or more known processes associated with the assembly; selecting a selected known process from the one or more known processes; displaying an image feed representing the real-world scene and the virtual model of the assembly overlaid over the real-world scene; and outputting one or more instructions corresponding to the selected known process.

In some embodiments, displaying the virtual model of the assembly overlaid over the real-world scene comprises orienting the virtual model relative to the real-world scene based on a detected user device position or orientation.

In some embodiments, displaying the virtual model of the assembly overlaid over the real-world scene comprises orienting the virtual model relative to the real-world scene based on a pose of the optical fiducial.

In some embodiments, retrieving from the context repository data associated with the assembly comprises retrieving data associated with a unique identifier obtained by decoding the optical fiducial.

In some embodiments, displaying the virtual model of the assembly overlaid over the real-world scene comprises highlighting at least one component of the assembly on the virtual model.

In some embodiments, displaying the virtual model of the assembly overlaid over the real-world scene comprises varying a number of components of the assembly that are displayed by the virtual model.

In some embodiments, displaying the virtual model of the assembly overlaid over the real-world scene comprises rendering the virtual model for each frame of the image feed.

In some embodiments, displaying the real-world model of the assembly overlaid over the real-world scene comprises rendering the virtual model in real time.

In some embodiments, displaying the image feed representing the real-world scene and the virtual model of the assembly overlaid over the real-world scene comprises generating an augmented reality (AR) or mixed reality (MR) environment.

In some embodiments, the one or more instructions corresponding to the selected known process comprise guidance for completing the selected known process, consolidated information associated with the selected known process or both.

Another aspect of the present disclosure provides a system comprising a processor. The processor may be configured to: capture one or more images of a real-world scene, the real-world scene including an assembly; identify the assembly using an optical fiducial imaged in at least one of the one or more captured images of the real-world scene; retrieve, from a context repository, data associated with the assembly, the data including a virtual model of the assembly and one or more known processes associated with the assembly; select a selected known process from the one or more known processes; display an image feed representing the real-world scene and the virtual model of the assembly overlaid over the real-world scene; and output one or more instructions corresponding to the selected known process.

In some embodiments, the processor is configured to display the virtual model of the assembly overlaid over the real-world scene by orienting the virtual model relative to the real-world scene based on a detected user device position or orientation.

In some embodiments, the processor is configured to display the virtual model of the assembly overlaid over the real-world scene by orienting the virtual model relative to the real-world scene based on a pose of the optical fiducial.

In some embodiments, the processor is configured to retrieve from the context repository data associated with the assembly by retrieving data associated with a unique identifier obtained by decoding the optical fiducial.

In some embodiments, the processor is configured to display the virtual model of the assembly overlaid over the real-world scene by highlighting at least one component of the assembly on the virtual model.

In some embodiments, the processor is configured to display the virtual model of the assembly overlaid over the real-world scene by varying a number of components of the assembly that are displayed by the virtual model.

In some embodiments, the processor is configured to display the virtual model of the assembly overlaid over the real-world scene by rendering the virtual model for each frame of the image feed.

In some embodiments, the processor is configured to display the virtual model of the assembly overlaid over the scene by rendering the virtual model in real time.

In some embodiments, the processor is configured to display the image feed representing the real-world scene and the virtual model of the assembly overlaid over the real-world scene by generating an augmented reality (AR) or mixed reality (MR) environment.

In some embodiments, the one or more instructions corresponding to the selected known process comprise guidance for completing the selected known process, consolidated information associated with the selected known process or both.

Another aspect of the present disclosure provides a non-transitory computer readable medium storing computer executable instructions thereon that when executed by a processor cause the processor to perform the method steps of any method described herein.

### BRIEF DESCRIPTION OF THE DRAWINGS

Example embodiments are provided in the accompanying detailed description which may be best understood in conjunction with the accompanying diagrams where:

FIG. 1 is a schematic block diagram of a software system according to an embodiment of the present disclosure;

FIG. 2 is a schematic diagram of example user interactions;

FIG. 3 is a schematic diagram of a module according to an embodiment of the present disclosure;

FIG. 4 is a schematic diagram of a module according to an embodiment of the present disclosure;

FIG. 5 is a schematic diagram of a module according to an embodiment of the present disclosure;

FIG. 6 is a schematic diagram of a module according to an embodiment of the present disclosure;

FIG. 7 is a schematic diagram of a module according to an embodiment of the present disclosure;

FIG. 8 is a block diagram illustrating a method according to an embodiment of the present disclosure; and

FIG. 9 is a schematic diagram of an example user device.

### DETAILED DESCRIPTION

The following discussion provides many example embodiments of the present disclosure. Although each embodiment represents a single combination of elements, the disclosure is considered to include all possible combinations of the disclosed elements.

Traditional training for an assembly (e.g., for maintenance or repair of the assembly) may be time consuming and/or inefficient. For example, a user may retain less than 25% of information provided by traditional training. A generalized training course may lack focus while a specialized course may overload a user with information. A traditional training course may be awareness-based rather than being application-focused. For example, traditional training may provide a user with information that is not specific to the user's particular context. The present disclosure provides many example embodiments of systems and methods which may provide detailed guidance and/or assistance to a user with respect to known processes associated with an assembly, including processes for performing maintenance or a repair of an assembly or one or more components of the assembly. The systems and methods may present or output context-specific information tailored to a particular application (e.g., a particular maintenance procedure or repair being performed on an assembly), for example based on the user's specific view of the assembly. In some embodiments, the context-specific information is presented in real time to avoid overloading a user with unnecessary information. By providing the context-specific guidance and/or assistance to the user, the likelihood of the process (e.g., maintenance or repair) being performed correctly is increased. Additionally, or alternatively, by providing the context-specific guidance and/or assistance to the user, an amount of time that a user takes to complete the process may be reduced.

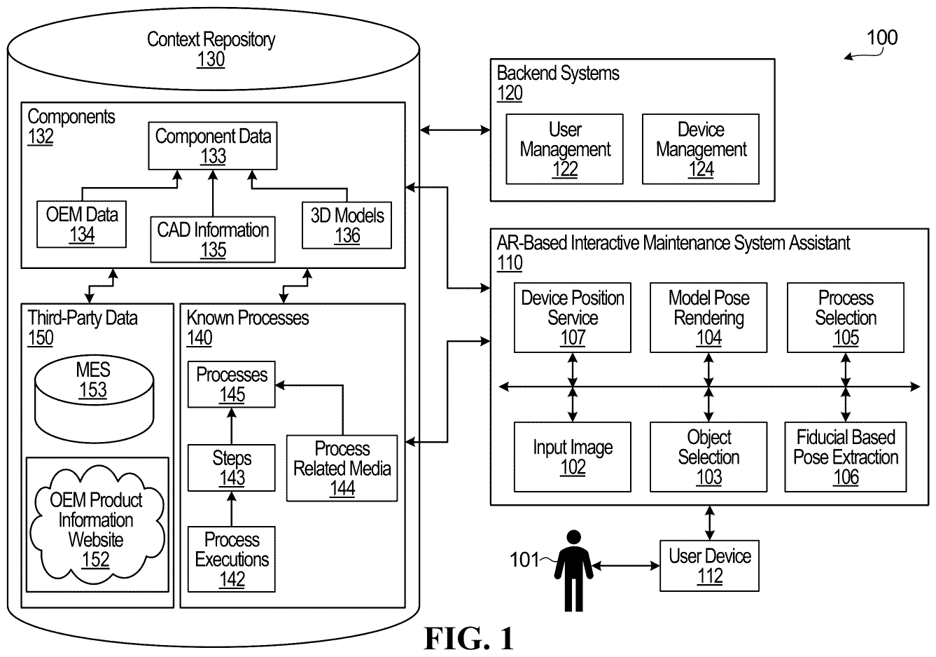

FIG. 1 is a block diagram illustrating an example embodiment of a software system 100, in accordance with the present disclosure. The software system 100 may facilitate user interaction in augmented reality (AR) or mixed reality (MR) with a virtual model of at least a portion of an assembly that may undergo maintenance and/or repair. The model may be, or may include, a three-dimensional (3D) model. An assembly may be, or may include, a physical system or apparatus which includes a plurality of components. For example, an assembly may be, or may include, an electrical panel assembly, a conveyor belt assembly in a manufacturing facility, an engine, a circuit, etc.

When a user desires to view information about an assembly (e.g., to perform maintenance or a repair of an assembly), the user may interact with software system 100 to obtain information related to the assembly (e.g., including information for maintenance or repair of the assembly). The obtained information may assist or guide the user when interacting with the assembly (e.g., for performing the maintenance or repair) and may increase the likelihood of the maintenance or repair, or other process using the assembly, being performed correctly.

The model of at least a portion of the assembly the user will be interacting with (e.g., for performing maintenance or a repair of) may be presented to a user overlaid over a real-world image or video feed showing the current environment (or scene) surrounding the user. The user may then interact with the model, as described elsewhere herein, to select components for which the user will be interacting with and to have those components displayed as desired by the user. For example, the user may provide input to suppress or highlight specific components of the assembly, may remove specific components from being displayed, etc. Based on the user's selection of components, the user may be presented with further information corresponding to the components and/or with potential known processes corresponding to the components which may be performed by the user. In some embodiments, the user may interact with the model in an AR environment. In some embodiments, the user may interact with the model in a MR environment. More generally, the user may interact with the model in an extended reality (XR) environment. It should be understood that references to AR or MR in the present disclosure may more generally encompass XR.

The software system 100 may guide the user in completing the desired interaction or process (e.g., maintenance or repair of the assembly). For example, the software system 100 may sequentially present steps of the desired interaction or process to the user. For each step, any components corresponding to the step may be highlighted or otherwise identified in the model for easy identification by the user.

In the example shown, the software system 100 includes an interactive maintenance system assistant 110, a user device 112 (which may accept inputs from and provide outputs to a user), backend systems 120 and a context repository 130. The interactive maintenance system assistant 110 may be implemented on the user device 112. For example, the user device 112 may locally render a model for presentation to the user. The backend systems 120 may be run on a computing device that is remote from the user device 112 such as a server. The context repository 130 may also be hosted on a computing device that is remote from the user device. The computing device that hosts the context repository 130 may be the same computing device as, or a different computing device than, the computing device that runs the backend systems 120.

The software system 100 may include an interactive maintenance system assistant 110, which may be an application executed by the user device 112. The interactive maintenance system assistant 110 may include one or more modules (or processes) which may capture user input, interpret the user input and/or facilitate AR or MR user interaction with the model of at least a portion of the assembly. Different ones of the modules (or processes) may be combined together into a single module (or process) or separated out into further modules (or processes). In the illustrated embodiment, the interactive maintenance system assistant 110 is AR-based (e.g., facilitates user interaction in AR). However, the interactive maintenance system assistant 110 need not be AR-based. In some embodiments, the interactive maintenance system assistant 110 is MR-based (e.g., facilitates user interaction in MR).

In the illustrated embodiment, the interactive maintenance system assistant 110 includes an input image module 102, an object selection module 103, a model pose rendering module 104, a process selection module 105, a fiducial based pose extraction module 106 and a device position service module 107. The modules of the interactive maintenance system assistant 110 may interact with one another.

The input image module 102 may obtain or acquire one or more images of a real-world environment or scene. For example, the one or more images may be acquired using a camera of a user device (such as user device 112 described elsewhere herein). In some embodiments, the input image module 102 obtains video data comprising a plurality of image frames.

Fiducial based pose extraction module 106 may identify at least one optical fiducial in the obtained one or more images. An optical fiducial may be a visual identifier (such as series of dots, a pattern of stripes, etc., for example) which corresponds to an assembly. In some embodiments, an optical fiducial uniquely identifies an assembly. For example, an optical fiducial may be, or may include, a QR code which uniquely identifies an assembly. A user's interest in a particular assembly may be identified by the software system 100 detecting an optical fiducial corresponding to the assembly in the obtained one or more images. If two or more optical fiducials are present in the obtained one or more images, a user may be prompted to select which assembly is of interest. An optical fiducial may also be referred to herein as a “fiducial mark”or a “fiducial code”.

Once an assembly is identified, a model of the assembly may be obtained (such as from a context repository or other datastore as described elsewhere herein). The object selection module 103 may facilitate user selection of one or more components of interest. The model pose rendering module 104 may facilitate rendering of the model by the user device 112 to present the one or more components of interest to the user.

The process section module 105 may facilitate user selection of a known process associated with the selected assembly or components of interest. For the purposes described herein, a “known process” is a pre-developed process which may be performed on the selected components of interest. A known process may be, or may include a pre-defined set of information or process steps that a user may want to view involving any of the components of an assembly stored in, for example, the context repository. A known process may include maintenance steps (e.g. for presentation to the user in plain text, or scripted/interactive videos and animations), highlighting of component interconnectivity or operator training routines for the assembly, components or subcomponents. A known process may be, or may include, a manufacturer's maintenance procedure for a component (e.g., how to lubricate including guidance relating to any components that may need to be removed and in what order), a repair procedure (e.g., how to repair a malfunctioning component including guidance relating to any components that may need to be removed or replaced and in what order), an in-house procedure developed specifically for the assembly by the owner or operator of the assembly. A known process may include a process for accessing a desired component if the component is not currently accessible (e.g., what components need to be removed and in what order for the desired component to be accessible). More generally, a known process may encompass any pre-defined set of steps for a certain user interaction (in particular an approved, validated and/or authorized user interaction) with the assembly.

The device position service module 107 may obtain a position and/or orientation of a user device 112 (e.g., obtained from position and/or orientation sensors of the user device 112, such as inertial measurement unit (IMU), accelerometers and/or gyroscopes of the user device 112). The rendering of the model presented to the user may be updated based on the obtained position and/or orientation of the user device 112. In some embodiments, the rendering of the model is updated in real-time based on the obtained position and/or orientation of the user device 112.

A user may provide their input to and/or be presented with output from the software system 100 via the user device 112. A user may interact with the interactive maintenance system assistant 110 with the user device 112. In some embodiments, the user device 112 is configured to detect or collect one or more user interactions 101 (e.g., one or more user inputs indicating a desired selection by the user).

The user device 112 may be, or may include, a mobile device such as a smartphone or tablet, for example. In some embodiments, the user device 112 is, or includes, a wearable device such as smart glasses or an AR headset, for example. In some embodiments, the user device 112 is, or includes, both a mobile device and a wearable device (e.g. both a smartphone and smart glasses which are paired together).

The software system 100 may also include one or more backend systems 120. In the illustrated embodiment, the backend system 120 include a user management module 122 and a device management module 124. The user management module 122 may facilitate management of one or more users of the software system 100 (e.g., management one or more user accounts, manage number of users at any given time, etc.). The device management module 124 may facilitate management of one or more devices interacting with or running the software system 100 (e.g., keep track of any devices interacting with or running the software system 100, limiting the number of user devices, etc.).

The software system 100 may also include a context repository 130. The context repository 130 may be, or may include, a database of files that represent information corresponding to the assembly and related known processes. The context repository 130 may, for example, store Computer Aided Design (CAD) information for machinery and electrical designs, 3D Object Models for full machine assembly and sub-components, Original Equipment Manufacturer (OEM) component data (including, but not limited to user manuals, datasheets and links to product webpages) and data (e.g., media) relevant to defined known processes.

In the illustrated embodiment, the context repository 130 includes components data 132, know processes data 140 and third-party data 150.

The components data 132 may include data representing information related to entire assemblies or components of individual assemblies. For example, the components data 132 may include component data 133 which represents information related to an individual component of an assembly. In the illustrated embodiment, the component data 133 includes OEM component data 134, CAD information 135 (e.g., one or more CAD drawings of the component) and 3D models data 136 (e.g., data representing one or more 3D models of the component).

In some embodiments, the components data 132 includes at least one data set representing an assembly. The data set may include a model of each component of the assembly. In some embodiments, a data set corresponding to an assembly includes component data 133 for each component of the assembly.

The known processes data 140 may include data representing information related to known processes of corresponding assemblies. Process data 145 for each known process may include process exactions or instructions 142 which may be executed by the software system 100 to at least partially implement the known process (e.g., computer executable instructions that when executed by the software system 100 facilitate performance of the known process such as instructions causing the software system 100 to render a specific portion of a model to illustrate a step of the process). Process data 145 may include steps data 143 identifying one or more steps to be taken by the user and/or process related media 144 including media related to the corresponding known process which may be presented to a user (e.g., one or more images, one or more video tutorials, etc.).

The third-party data 150 may include data representing third-party information related to an assembly or component. For example, the third-party data 150 may include manufacturing execution system (MES) data 153 and/or OEM product information web data 152.

Data in the context repository 130 may be organized by assembly. In some embodiments, data is indexed using a unique identifier of each corresponding assembly. In some such embodiments, an identifier of an assembly obtained, for example, from a decoded optical fiducial of the assembly may be used to retrieve data (e.g., one or more models, potential known processes, etc.) corresponding to the assembly from the context repository 130.

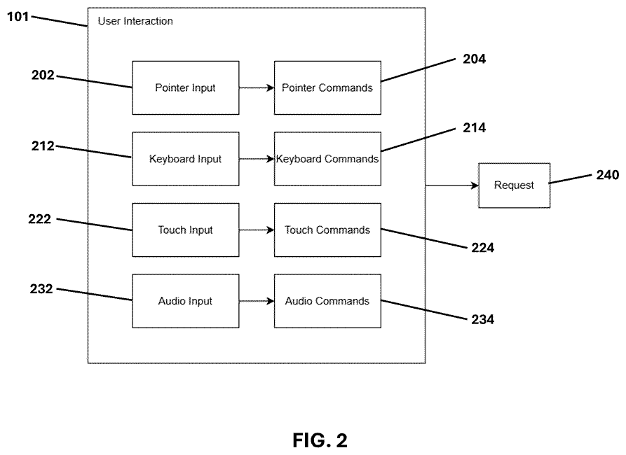

FIG. 2 schematically illustrates example user inputs or user interactions 101 that a user may provide when interacting with the software system 100.

The user interactions 101 may be, or may include, pointer input 202 (e.g., pointer input using a mouse or pointing device, a pointer input recognized as part of a smart glasses platform, etc.). The pointer input 202 may be decoded into one or more pointer commands 204 representing an intended action or selection by the user. Pointer interactions may be done by whatever action is required to initiate a “Click” event/command.

Additionally, or alternatively, the user interactions 101 may be, or may include, keyboard input 212 (e.g., input provided by a user's use of a keyboard). The keyboard input 212 may be decoded into one or more keyboard commands 214 representing an intended action or selection by the user. In some embodiments, a keyboard (which may include an on-screen keyboard) may be used by a user to write one or more queries with prompt-based keywords, or in natural language, and commands which can be processed via a large language model (LLM).

Additionally, or alternatively, the user interactions 101 may be, or may include, touch input 222 (e.g., input provided by a user's use of a touchscreen). The touch input 222 may be decoded into one or more touch commands 224 representing an intended action or selection by the user. Touchscreen interactions may be done by a user through interacting with a displayed model on their mobile device.

In some embodiments, touch inputs 222 (and/or pointer inputs 202) may be provided by a user when the user interacts with a contextually populated menu, where the user can, for example, select any of the available known processes to view.

Additionally, or alternatively, the user interactions 101 may be, or may include, audio input 232 (e.g., input provided by capturing audio from the user). The audio input 232 may be decoded into one or more audio commands 234 representing an intended action or selection by the user.

Inputs and/or decoded commands of the user interactions 101 may be combined into a request 240. The request 240 may be provided to the software system 100 to indicate the user's intention.

A user may provide one or more audio inputs 232 in natural sentence structure. Such audio inputs 232 may be processed by a large language model (LLM) such as Dolly™, Bloom™ or ChatGPT™ to extract key word prompts for use by the interactive maintenance system assistant 110 or the software system 100 generally. Other voice-recognition techniques may be used to extract one or more key word prompts from the audio inputs 232. For example, the key word prompts may be provided to the object selection module 103 and/or the process selection module 105.

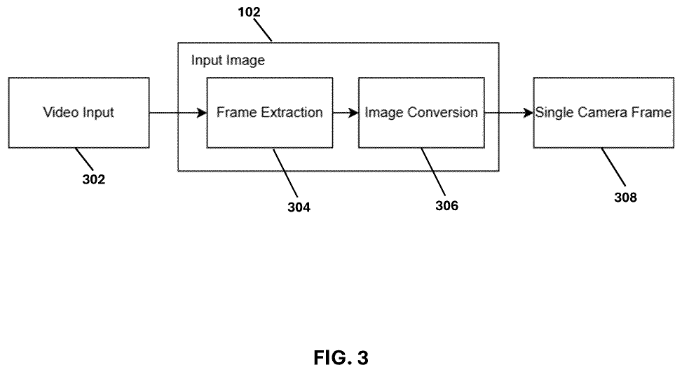

FIG. 3 schematically illustrates an example embodiment of the input image module 102. The input image module 102 may receive as input video input 302. The video input 302 may be captured by at least one camera of the user device 112. The video input 302 comprises a plurality of image frames (e.g., a plurality of images). In the illustrated embodiment, the input image module 102 includes a frame extraction module 304 and an image conversion module 306. The frame extraction module 304 may extract individual image frames from the video input 302. The image conversion module 306 may convert the image frames into a desired format. The input image module 102 may output the one or more extracted and/or converted single camera frames 308 (which may also be referred to as “single image frames” or “images”).

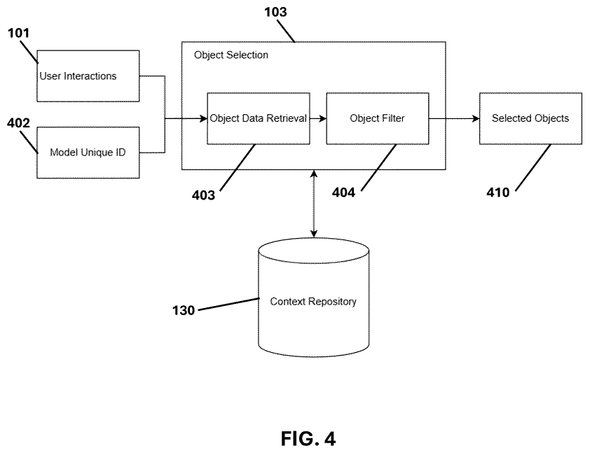

FIG. 4 schematically illustrates an example embodiment of the object selection module 103. The object selection module 103 may receive as input the user interactions 101 and a model unique ID 402. The user interactions 101 may at least partially determine what data and 3D model is retrieved from the context repository 130 and eventually rendered in the AR/MR environment. The model unique ID 402 may be obtained by decoding an optical fiducial as described elsewhere herein. The object selection module 103 may output one or more selected objects 410 to be presented to the user. In the illustrated embodiment, the object selection module 103 includes an object data retrieval module 403 and an object filter module 404. The object data retrieval module 403 may retrieve information or data (such as a 3D model) relevant to an assembly or one or more components of the assembly from the context repository 130. The object filter module 404 may determine which components of the assembly are presented to the user. Which components of the assembly are presented to the user may at least in part be responsive to user input. For example, a user may select certain components to be hidden to provide a better view of a desired component. As another example, the user may wish to highlight in the model a component of interest (e.g., a component that needs to be removed and replaced to complete the maintenance). In some embodiments, which components of the assembly are presented to the user is at least partially responsive to a known process selected by the user (e.g., the known process at least partially indicates which components are to be presented to the user).

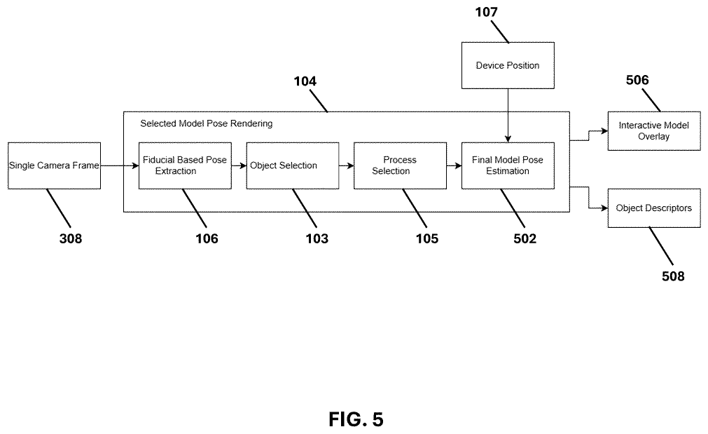

FIG. 5 is a block diagram illustrating an example embodiment of the model pose rendering module 104. The model pose rendering module 104 may render a model for presentation to the user. The model pose rendering module 104 may receive as input a single camera frame 308.

In the illustrated embodiment, the model pose rendering module 104 includes the fiducial based pose extraction module 106, the object selection module 103, the process selection module 105 and a final model pose estimation module 502. In some embodiments, the model pose rendering module 104 includes a different number of modules or different modules than in the illustrated embodiment. For example, in some embodiments, the model pose rendering module 104 includes only the final model pose estimation module 502.

The fiducial based pose extraction module 106 may detect and decode an optical fiducial as described elsewhere herein. The object selection module 103 may determine which components of an assembly to present to a user as described elsewhere herein. The process selection module 105 may determine what known process is to be performed by the user as described elsewhere herein. The final model pose estimation may determine exactly how to render the model for presentation to the user. The final model pose may be at least partially based on a position and/or orientation of the user device 112. Position and/or orientation of the user device 112 may be determined by the device position module 107. Based on the determined position and/or orientation, the rendering of the model may be updated. In some embodiments, the model pose estimation is performed on a frame-by-frame basis. In some embodiments, the model pose estimation is performed in real time.

The model pose rendering module 104 may output an interactive model overlay 506 to be presented to the user and/or one or more object descriptors 508. The one or more object descriptors 508 may include information corresponding to the presented components which may be relevant to the user. The interactive model overlay 506 may be overlaid over a real-time image feed of a real-world environment or scene.

In some embodiments, if no models are currently rendered in the AR/MR environment, then the 3D pose of the optical fiducial may be first extracted and decoded from an input image (e.g., an image captured by the user device 112). Once the optical fiducial is decoded, a 3D model of the complete machine assembly (otherwise referred to herein as an “assembly”) may be retrieved from the context repository 130 and may be rendered by the software system 100 for presentation to the user (e.g., by using the user device 112). The user may then further interact with the model to select specific objects/components and the software system 100 may render an updated 3D model or may retrieve an updated 3D model from the context repository 130 and render the retrieved updated 3D model as required. An initial location of the optical fiducial and a position and/or orientation of the user device 112, as determined for example by the device position service 107, may be used to determine the final pose of the selected 3D model to be rendered as the output image to the user device 112. A list of object descriptors that reference known processes of the context repository 130 may be populated for the selected object(s)/component(s).

An optical fiducial (such as a QR code as described elsewhere herein) may be placed on a physical assembly. This optical fiducial may be scanned by the user device 112 to decode a unique identifier for all, or a portion, of the relevant data to be recalled from the context repository 130 including at least one virtual model (e.g., a 3D model) of the assembly and/or components of the assembly for AR or MR display to the user. A location and/or orientation for the rendering of the model in the AR/MR environment to match the associated real-world objects may at least partially be determined by the optical fiducial's location in the model data and the pose (cartesian location and rotational orientation) of the optical fiducial on the real-world equipment/assembly during performance of the fiducial based pose extraction module 106.

While the interactive maintenance system assistant 110 is being run (e.g., which may be done by running a software application on the user device 112), the position and/or orientation of the user device 112 may be continually tracked by the device position service 107. The position and/or orientation of the user device 112 may be performed by one or more internal systems of the user device 112. Additionally, or alternatively, the position and/or orientation of the user device 112 may be determined using various 3D tracking algorithms such as OpenPose, in combination with cameras, LiDAR sensors, and one or more IMUs of the user device 112. The tracked position/orientation of the user device 112 may allow for the rendering of the model to be displayed and updated to match the associated real-world equipment/assembly, even if the optical fiducial cannot be seen in the current video/image data being acquired by the user device 112. Contextual menus including options to view known processes may become visible at the location of relevant components in the rendered 3D model for further user interaction. The position of these menus may also be updated based on the position/orientation of the user device 112.

If and when a user has selected a known process, the rendered 3D objects in the AR/MR environment may be updated to reflect this process. If the user has selected to suppress or highlight a specific number of components of the assembly, certain components may be removed from the rendered 3D model of the assembly, or a new 3D model containing fewer components may be rendered in the place of the complete assembly.

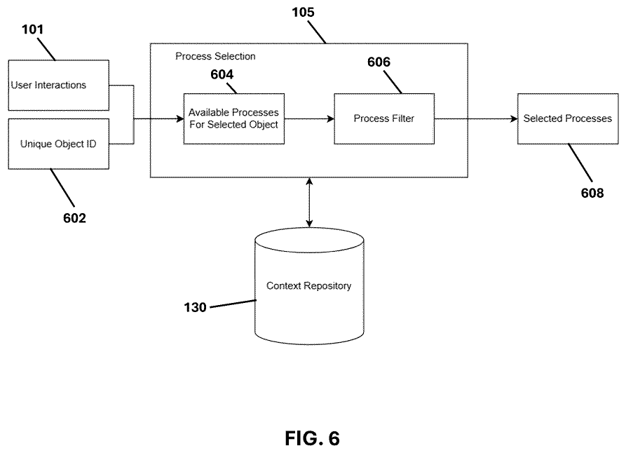

FIG. 6 is a block diagram illustrating an example embodiment of the process selection module 105. The process selection module 105 may receive as input the user interactions 101 and a model unique ID 602. The model unique ID 602 may be similar to the model unique ID 402 described elsewhere herein. The process selection module 105 may output one or more selected processes 608 to be presented to the user. In the illustrated embodiment, the process selection module 105 includes an available process for selected object module 604 and a process filter module 606. The available processes for selected object module 604 may retrieve information or data relevant to one or more known processes corresponding to a selected assembly or one or more selected components of the assembly from the context repository 130. The process filter module 606 may determine which known process the user would like to select. The process filter module 606 may be responsive to user input or context provided by the user. For example, available known processes may be presented to a user (e.g., in a drop-down menu) and the user may select a known process they intend to proceed with.

Selection of a known process may be at least partially based on currently available object descriptors of a current model being rendered (e.g., a current state of a model such as which components are visible and not visible and/or the current progress of any maintenance being performed may inform which further known processes may be available to a user based on the current state).

By rendering and presenting to the user a model which includes components of interest of an assembly, computational efficiency may be increased as components of the assembly that are not of interest need not be rendered.

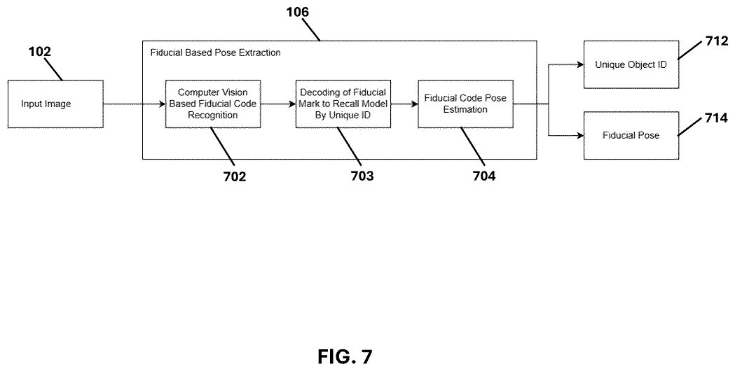

FIG. 7 illustrates an example embodiment of the fiducial based pose extraction module 106. The fiducial based pose extraction module 106 may receive as input an output of the input image module 102 (such as single camera frame 308, for example). The fiducial based pose extraction module 106 may output a unique object ID 712 and a fiducial pose 714. The unique object ID 712 may be similar to the unique object ID 402 or 602. Data including a model and/or known processes corresponding to the assembly may be retrieved from the context repository 130 using the unique object ID 712. The fiducial pose 714 may identify or represent an orientation of the assembly relative to the user device 112. The fiducial pose 714 may at least partially assist with correctly orienting and overlaying the model over the image feed of the environment/scene as described elsewhere herein.

In the illustrated embodiment, the fiducial based pose extraction module 106 includes a computer vision based fiducial code recognition module 702, a decoding of fiducial mark to recall model by unique ID module 703 and a fiducial code pose estimation module 704. The computer vision based fiducial code recognition module 702 may use computer vision (such as a trained model, or other image processing techniques) to detect an optical fiducial in one or more images. The decoding of fiducial mark to recall model by unique ID module 703 may decode a detected optical fiducial to obtain an identifier which is represented by the optical fiducial. As described elsewhere herein, the identifier may uniquely identify an assembly but does not need to in all embodiments. The fiducial code pose estimation module 704 may determine a pose (such as a 3D pose) of the imaged optical fiducial.

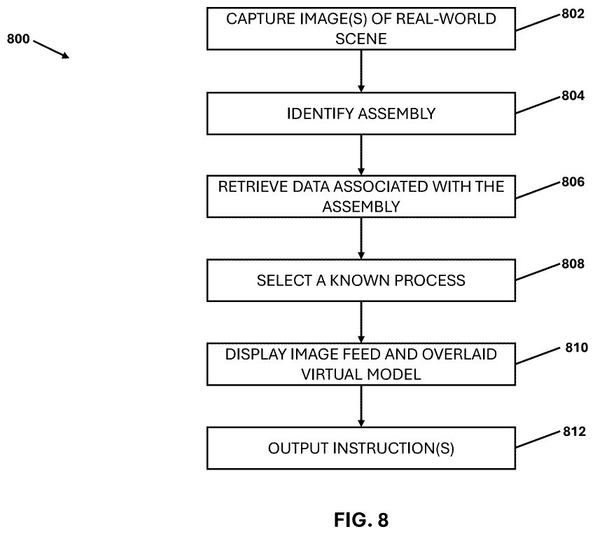

FIG. 8 illustrates an example method 800. Method 800 may be performed by a user device such as the user device 112, for example.

At step 802, one or more images of a real-world scene or environment may be captured (e.g., with the user device 112). The real-world scene may include an assembly.

At step 804, the assembly may be identified using an optical fiducial imaged in at least one of the captured image(s) of the real-world scene.

At step 806, data associated with the assembly may be retrieved from a context repository (such as the context repository 130). The data may include a virtual model of the assembly and one or more known processes associated with the assembly.

At step 808, selection of a selected known process from the one or more retrieved known processes may be obtained. For example, user input representing selection by the user of a known process from the one or more known processes may be obtained. As described herein, a user may view potential known processes and select a known process from the retrieved known processes. In some examples, there may be only one known process retrieved at step 806 and that one known process may be selected automatically. In other examples, a default known process may be automatically selected by default, without requiring user input.

At step 810, an image feed representing the real-world scene and the virtual model of the assembly overlaid over the real-world scene may be displayed (e.g., by the user device 112, to be viewed by the user).

At step 812, one or more instructions corresponding to the selected known process may be outputted. For example, instructions corresponding to sequential steps of the selected known process may be sequentially presented to the user. The instructions may, for example, be presented by present text output to the user, graphic output to the user, audio output to the user, various combinations of two or more thereof, etc. In some examples, the instructions may be provided in the form of a virtual assistant or other guidance in the AR environment. The virtual assistant may, in some examples, be provided via an artificial intelligence agent (e.g., an LLM agent), and may consolidate information regarding one or more steps of the selected known process. Each sequential step of the selected known process may be presented, one at a time, based on the user interaction with the assembly and/or based on user input.

For example, the first step of the selected known process may be first outputted by default. Based on user interaction with the assembly (e.g., moving around the assembly, exposing a component of the assembly, etc.), an instruction for a next sequential step of the selected known process may be automatically outputted. Progress or completion of a selected known process, or one or more steps of the selected known process, may be autonomously monitored by, for example, using one or more artificial intelligence models (which may be a module of the interactive maintenance system assistant 110, or may be hosted by a remote server and accessible by the interactive maintenance system assistant 110), one or more computer vision processes and/or systems, etc. For example, if one step of the selected known process instructs the user to find or expose a particular component, then after the user interacts with the assembly such that the particular component is captured in the image feed (e.g., the particular component may be recognized by the computer vision based fiducial code recognition module 702, based on an optical fiducial placed on the particular component), the next step of the selected known process may be automatically outputted to the user. In another example, if one step of the selected known process instructs the user to change the position or orientation of a particular component of the assembly, then after the user interacts with the assembly to change the position or orientation of the particular component as instructed, this change in position or orientation of the particular component may be detected by the computer vision based fiducial code recognition module 702 (e.g., based on the changed position or orientation of the optical fiducial placed on the particular component), and the next step of the selected known process may be automatically outputted to the user.

In some examples, sequential steps of the selected known process may be presented to the user based on user input. For example, the user may provide touch input or audio input to indicate that they wish to proceed to the next step in the selected known process.

In some examples, when each step of the selected known process is outputted, one or more relevant components of the assembly may be highlighted on the virtual model. In another example, when each step of the selected known process is outputted, one or more irrelevant components of the assembly may be hidden on the virtual model, to enable the user to more clearly view the relevant component(s). The relevant/irrelevant component(s) may be updated as the user moves through the steps of the selected known process, with appropriate updating of which component(s) are highlighted and/or hidden on the virtual model. In this way, the user may be visually guided through the steps of the selected known process in an intuitive manner.

In another example, one or more steps of the selected known process may be outputted using a floating window, which may be displayed in the AR environment, operable to display media or information related to the one or more steps (e.g., to guide a user). The media or information related to the one or more steps is an example of guidance for completing the selected known process or consolidated information associated with the selected known process or both which may be outputted. The media or information related to the one or more steps may be retrieved from the context repository 130. The floating window may output (e.g. for presentation to a user) one or more context menus, one or more video players, one or more images, etc. The floating window may be at least partially overlaid over an image feed of the real-world scene, the virtual model or both.

The steps of the method 800 need not occur sequentially. For example, two or more steps of the method 800 may occur concurrently. For example, the steps 810 and 812 may occur concurrently. The steps of the method 800 may occur in a different order than what is illustrated in FIG. 8.

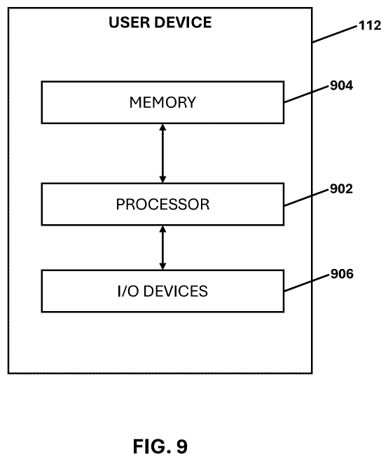

FIG. 9 schematically illustrates an example embodiment of a user device 112. In the illustrated embodiment, the user device 112 includes at least one processor 902 and memory (or datastore) 904. The memory 904 may store computer executable instructions that when executed by the processor 902 cause the user device 112 to perform a method or process described herein (such as the method 800, for example). In some embodiments, the memory 904 stores computer executable instructions that when executed by the processor 902 cause the user device 112 to implement one or more modules of the software system 100 (such as the interactive maintenance system assistant 110, for example). The user device 112 may also include one or more input/output (I/O) devices 906 which may be configured to receive user input and/or present outputs to a user. For example, the I/O devices 906 may include a touchscreen, a display screen, a keyboard, a track pad, one or more speakers, one or more microphones, etc.

It will be appreciated by those skilled in the art that changes could be made to the various aspects of the subject application described above without departing from the scope of the present disclosure. It is to be understood, therefore, that this subject application is not limited to the particular aspects disclosed, but it is intended to cover modifications as defined by the appended claims.

When introducing elements of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed element.

1. A method comprising:
capturing one or more images of a real-world scene, the real-world scene including an assembly;
identifying the assembly using an optical fiducial imaged in at least one of the one or more captured images of the real-world scene;
retrieving, from a context repository, data associated with the assembly, the data including a virtual model of the assembly and one or more known processes associated with the assembly;
selecting a selected known process from the one or more known processes;
displaying an image feed representing the real-world scene and the virtual model of the assembly overlaid over the real-world scene; and
outputting one or more instructions corresponding to the selected known process.

2. The method of claim 1, wherein displaying the virtual model of the assembly overlaid over the real-world scene comprises orienting the virtual model relative to the real-world scene based on a detected user device position or orientation.

3. The method of claim 1, wherein displaying the virtual model of the assembly overlaid over the real-world scene comprises orienting the virtual model relative to the real-world scene based on a pose of the optical fiducial.

4. The method of claim 1, wherein retrieving from the context repository data associated with the assembly comprises retrieving data associated with a unique identifier obtained by decoding the optical fiducial.

5. The method of claim 1, wherein displaying the virtual model of the assembly overlaid over the real-world scene comprises highlighting at least one component of the assembly on the virtual model.

6. The method of claim 1, wherein displaying the virtual model of the assembly overlaid over the real-world scene comprises varying a number of components of the assembly that are displayed by the virtual model.

7. The method of claim 1, wherein displaying the virtual model of the assembly overlaid over the real-world scene comprises rendering the virtual model for each frame of the image feed.

8. The method of claim 1, wherein displaying the real-world model of the assembly overlaid over the real-world scene comprises rendering the virtual model in real time.

9. The method of claim 1, wherein displaying the image feed representing the real-world scene and the virtual model of the assembly overlaid over the real-world scene comprises generating an augmented reality (AR) or mixed reality (MR) environment.

10. The method of claim 1, wherein the one or more instructions corresponding to the selected known process comprise guidance for completing the selected known process, consolidated information associated with the selected known process or both.

11. A system comprising a processor, the processor configured to:
capture one or more images of a real-world scene, the real-world scene including an assembly;
identify the assembly using an optical fiducial imaged in at least one of the one or more captured images of the real-world scene;
retrieve, from a context repository, data associated with the assembly, the data including a virtual model of the assembly and one or more known processes associated with the assembly;
select a selected known process from the one or more known processes;
display an image feed representing the real-world scene and the virtual model of the assembly overlaid over the real-world scene; and
output one or more instructions corresponding to the selected known process.

12. The system of claim 11, wherein the processor is configured to display the virtual model of the assembly overlaid over the real-world scene by orienting the virtual model relative to the real-world scene based on a detected user device position or orientation.

13. The system of claim 11, wherein the processor is configured to display the virtual model of the assembly overlaid over the real-world scene by orienting the virtual model relative to the real-world scene based on a pose of the optical fiducial.

14. The system of claim 11, wherein the processor is configured to retrieve from the context repository data associated with the assembly by retrieving data associated with a unique identifier obtained by decoding the optical fiducial.

15. The system of claim 11, wherein the processor is configured to display the virtual model of the assembly overlaid over the real-world scene by highlighting at least one component of the assembly on the virtual model.

16. The system of claim 11, wherein the processor is configured to display the virtual model of the assembly overlaid over the real-world scene by varying a number of components of the assembly that are displayed by the virtual model.

17. The system of claim 11, wherein the processor is configured to display the virtual model of the assembly overlaid over the real-world scene by rendering the virtual model for each frame of the image feed, by rendering the virtual model in real time or both.

18. The system of claim 11, wherein the processor is configured to display the image feed representing the real-world scene and the virtual model of the assembly overlaid over the real-world scene by generating an augmented reality (AR) or mixed reality (MR) environment.

19. The system of claim 11, wherein the one or more instructions corresponding to the selected known process comprise guidance for completing the selected known process, consolidated information associated with the selected known process or both.

20. A non-transitory computer readable medium storing computer executable instructions thereon that when executed by a processor cause the processor to:
capture one or more images of a real-world scene, the real-world scene including an assembly;
identify the assembly using an optical fiducial imaged in at least one of the one or more captured images of the real-world scene;
retrieve, from a context repository, data associated with the assembly, the data including a virtual model of the assembly and one or more known processes associated with the assembly;
select a selected known process from the one or more known processes;
display an image feed representing the real-world scene and the virtual model of the assembly overlaid over the real-world scene; and
output one or more instructions corresponding to the selected known process.
